(19) United States
(12) Patent Application Publication
(10) Pub. No.: US 2022/0121191 A1
(43) Pub. Date: Apr. 21, 2022

(54) TIME-SERIES DATA PROCESSING METHOD

(71) Applicant: NEC Corporation, Minato-ku, Tokyo (JP)

(72) Inventor: Ryosuke TOGAWA, Tokyo (JP)

(73) Assignee: NEC Corporation, Minato-ku, Tokyo (JP)

(21) Appl. No.: 17/428,197

(22) PCT Filed: Feb. 14, 2019
(86) PCT No.: PCT/JP2019/005377

§ 371 Date: Aug. 3, 2021

(51) Int. Cl. G05B 23/02

(52) U.S. Cl. CPC G05B 23/0221; G05B 23/0256; G05B 23/0235

(57) ABSTRACT

A time-series data processing device 100 includes an analysis unit 121 that sets, on the basis of an analysis result with respect to first time-series data, a given section of the first time-series data, and an output unit 122 that, on the basis of the first time-series data included in the set section, controls output of information based on an analysis result with respect to second time-series data.

### TECHNICAL FIELD

The present invention relates to a time-series data processing method, a time-series data processing device, and a program.

### BACKGROUND ART

In plants such as production facilities and processing facilities, time-series data that is measurement values from various sensors is analyzed, and occurrence of an abnormal state is detected and output. For example, in Patent Literature 1, abnormality is detected on the basis of the degree of divergence between newly acquired measurement data and learning data. Moreover, in Patent Literature 1, in order to detect abnormality early with high sensitivity, update of data including addition of normal data to learning data and deletion of abnormal data is performed.
Patent Literature 1: JP 2010-191556 A

### SUMMARY

However, there is a case where abnormality information output as described above is unnecessary for a user who receives such output. For example, it is unnecessary to output abnormality detection based on time-series data during a maintenance work of a plant or during a part replacement work. Output of such unnecessary abnormality detection causes a problem that it becomes difficult for a user to perform accurate monitoring on an object of abnormality detection.

Therefore, an object of the present invention is to solve the aforementioned problem, that is, a problem that it becomes difficult for a user to perform accurate monitoring on a monitoring object.

A time-series data processing method according to one aspect of the present invention includes on the basis of an analysis result with respect to first time-series data, setting a given section of the first time-series data; and on the basis of the first time-series data included in the set section, controlling output of information based on an analysis result with respect to second time-series data.

Further, a time-series data processing method according to one aspect of the present invention includes on the basis of an analysis result with respect to first time-series data, setting a given section of the first time-series data; and

analyzing second time-series data, and outputting information representing an abnormal state of the second time-series data, wherein

the outputting the information representing the abnormal state of the second time-series data includes outputting information representing an abnormal state of the second time-series data corresponding to the first time-series data included in the set section, of the information representing the abnormal state of the second time-series data, so as to be distinguishable from the rest.

Further, a time-series data processing device according to one aspect of the present invention includes

an analysis unit that, on the basis of an analysis result with respect to first time-series data, sets a given section of the first time-series data; and

an output unit that, on the basis of the first time-series data included in the set section, controls output of information based on an analysis result with respect to second time-series data.

Further, a time-series data processing device according to one aspect of the present invention includes

an analysis unit that, on the basis of an analysis result with respect to first time-series data, sets a given section of the first time-series data, and analyzes second time-series data; and

an output unit that, on the basis of an analysis result of the second time-series data, outputs information representing an abnormal state of the second time-series data, wherein

when outputting the information representing the abnormal state of the second time-series data, the output unit outputs information representing an abnormal state of the second time-series data corresponding to the first time-series data included in the set section, of the information representing the abnormal state of the second time-series data, so as to be distinguishable from the rest.

Further, a program according to one aspect of the present invention is configured to cause an information processing device to execute processing of:

on the basis of an analysis result with respect to first time-series data, setting a given section of the first time-series data; and

on the basis of the first time-series data included in the set section, controlling output of information based on an analysis result with respect to second time-series data.

Further, a program according to one aspect of the present invention is configured to cause an information processing device to execute processing of:

on the basis of an analysis result with respect to first time-series data, setting a given section of the first time-series data; and

analyzing second time-series data, and outputting information representing an abnormal state of the second time-series data, wherein

the outputting the information representing the abnormal state of the second time-series data includes outputting information representing an abnormal state of the second time-series data corresponding to the first time-series data included in the set section, of the information representing the abnormal state of the second time-series data, so as to be distinguishable from the rest.

With the configurations described above, the present invention enables prevention of output of unnecessary abnormality detection with respect to time-series data, and enables improvements in the monitoring accuracy with respect to a monitoring object by a user.

### BRIEF DESCRIPTION OF DRAWINGS

FIG. 1 is a block diagram illustrating a configuration of a time-series data processing device according to a first exemplary embodiment of the present invention.

FIG. 2 is a block diagram illustrating a configuration of the analysis unit disclosed in FIG. 1.

FIG. 3 illustrates a state of processing time-series data by the time-series data processing device disclosed in FIG. 1.

FIG. 4 illustrates a state of processing time-series data by the time-series data processing device disclosed in FIG. 1.

FIG. 5 illustrates a state of processing time-series data by the time-series data processing device disclosed in FIG. 1.

FIG. 6 is a flowchart illustrating an operation of the time-series data processing device disclosed in FIG. 1.

FIG. 7 is a flowchart illustrating an operation of the time-series data processing device disclosed in FIG. 1.

FIG. 8 is a flowchart illustrating an operation of the time-series data processing device disclosed in FIG. 1.

FIG. 9 is a block diagram illustrating a hardware configuration of a time-series data processing device according to a second exemplary embodiment of the present invention.

FIG. 10 is a block diagram illustrating a configuration of the time-series data processing device according to the second exemplary embodiment of the present invention.

FIG. 11 is a flowchart illustrating an operation of the time-series data processing device according to the second exemplary embodiment of the present invention.

FIG. 12 is a flowchart illustrating an operation of the time-series data processing device according to the second exemplary embodiment of the present invention.

### EXEMPLARY EMBODIMENTS

### First Exemplary Embodiment

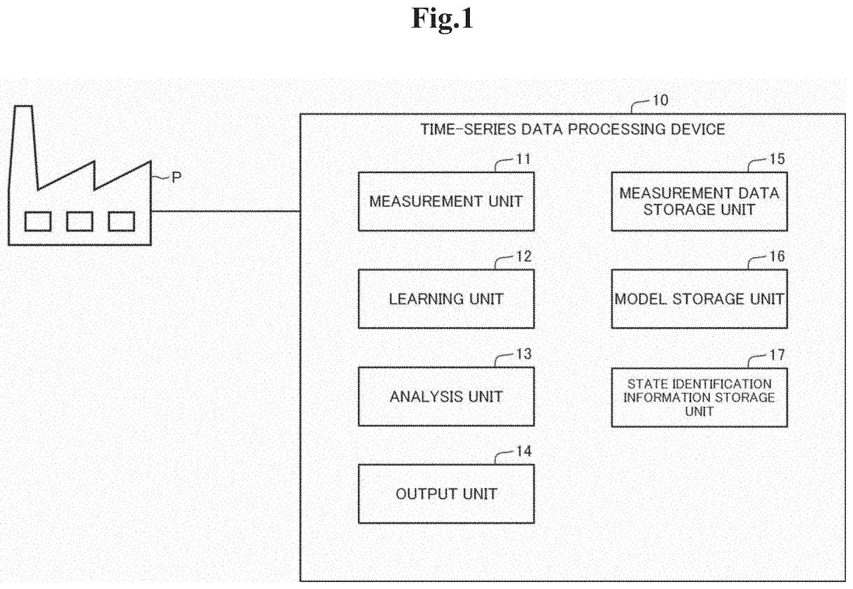

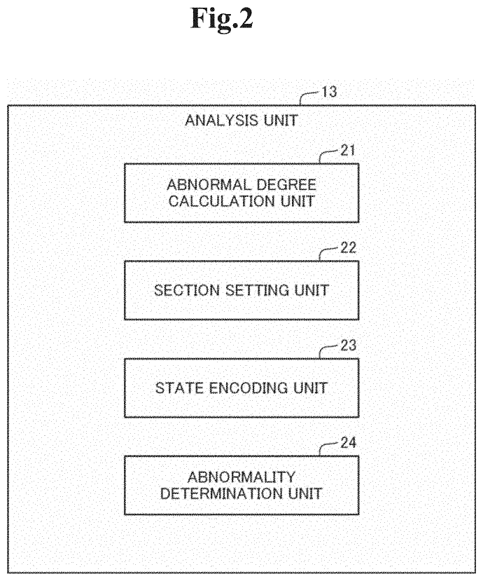

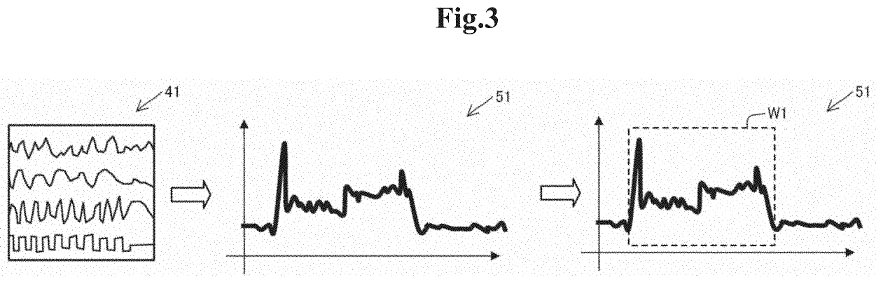

A first exemplary embodiment of the present invention will be described with reference to FIGS. 1 to 8. FIGS. 1 and 2 are diagrams for explaining a configuration of a time-series data processing device, and FIGS. 3 to 8 are illustrations for explaining the processing operation of the time-series data processing device.

### [Configuration]

A time-series data processing device 10 of the present invention is connected to a monitoring object P (object) such as a plant. The time-series data processing device 10 is used to acquire and analyze measurement values of the elements of the monitoring object P, and monitor the state of the monitoring object P on the basis of the analysis result. For example, the monitoring object P is a plant such as a production facility or a processing facility, and measurement values of the elements include a plurality of types of information such as temperature, pressure, flow rate, power consumption, the supply amount of material, and the remaining amount, in the plant. In the present embodiment, the state of the monitoring object P to be monitored is an abnormal state of the monitoring object P, and the abnormal degree calculated according to a preset standard is output, and notice information notifying that the monitoring object P is in an abnormal state is output.

However, the monitoring object P in the present invention is not limited to a plant, and may be anything such as equipment including an information processing system. For example, in the case where the monitoring object P is an information processing system, it is possible to measure utilization of the central processing unit (CPU), memory utilization, disk access frequency, the number of input/output packets, power consumption value, and the like of each information processing device constituting the information processing system as measurement values of the elements, and analyze such measurement values to monitor the state of the information processing system.

The time-series data processing device 10 is configured of one or a plurality of information processing devices each having an arithmetic unit and a storage unit. Then, as illustrated in FIG. 1, the time-series data processing device 10 includes a measurement unit 11, a learning unit 12, an analysis unit 13, and an output unit 14 that are constructed by execution of a program by the arithmetic unit. The time-series data processing device 10 also includes a measurement data storage unit 15, a model storage unit 16, and a state identification information storage unit 17 that are formed in a storage device. Hereinafter, each configuration will be described in detail.

The measurement unit 11 acquires measurement values of each element, measured by each type of sensor provided to the monitoring object P at certain time intervals, as time-series data, and stores them in the measurement data storage unit 15. Here, since there are a plurality of types of elements to be measured, the measurement unit 11 acquires a time-series data set that is a set of time-series data of a plurality of elements, as denoted by a reference numeral 41 in FIG. 3. Note that acquisition and storing of a time-series data set by the measurement unit 11 are performed regularly. The acquired time-series data set is used at the time of generating a correlation model representing the normal state of the monitoring object P, at the time of setting a notice unneeded period of an abnormal state of the monitoring object P, and at the time of monitoring the state of the monitoring object P, as described below.

The learning unit 12 inputs therein a time-series data set measured in advance when the monitoring object P is determined to be in a normal state, and generates a correlation model representing a correlation between elements in the normal state. For example, a correlation model includes a correlation function representing a correlation of measurement values of any two elements among the elements. A correlation function is a function that predicts an output value of the other element with respect to an input value of one element of any two elements. Here, a weight is set to a correlation function between elements included in the correlation model. The learning unit 12 generates a set of correlation functions between a plurality of elements as described above as a correlation model, and stores it in the model storage unit 16.

The analysis unit 13 acquires a time-series data set measured after generation of the correlation model described above, analyzes the time-series data set, and determines the state of the monitoring object P. As illustrated in FIG. 2, the analysis unit 13 includes an abnormal degree calculation unit 21, a section setting unit 22, a state encoding unit 23, and an abnormality determination unit 24, and performs a process of setting a notice unneeded period of an abnormal state of the monitoring object P and a process of analyzing and monitoring the state of the monitoring object P, as described below.

First, a process of setting a notice unneeded period of an abnormal state of the monitoring object P by the analysis unit 13 will be described. The abnormal degree calculation unit 21 inputs therein a time-series data set (first time-series data) measured from the monitoring object P, and calculates the abnormal degree (information representing an abnormal state) representing the degree that the monitoring object P is in an abnormal state, with use of a correlation model stored in the model storage unit 16. Specifically, with respect to the correlation function between given two elements, the abnormal degree calculation unit 21 inputs a measured input value of one element to predict an output value of the other element, and obtains the difference between the prediction value and an actual measurement value. Here, when the difference is a predetermined value or larger, the correlation between the two elements is detected as correlation destruction. Then, the abnormal degree calculation unit 21 obtains the differences in the correlation functions between elements and the situation of correlation destruction, and calculates the abnormal degree according to the magnitude of the difference, the weight of the correlation function, and the number of correlations in correlation destruction. For example, as the degree of correlation destruction is larger, the abnormal degree calculation unit 21 calculates the value of the abnormal degree to be higher because the possibility of the monitoring object P being in an abnormal state is assumed to be higher. Note that the abnormal degree calculation unit 21 calculates the abnormal degree for each time period of the time-series data set. However, the method of calculating the abnormal degree by the abnormal degree calculation unit 21 may be any method without being limited to the method described above.

As illustrated in FIG. 3, the section setting unit 22 outputs the values of the abnormal degree calculated from the time-series data set 41 by the abnormal degree calculation unit 21 in a time-series (horizontal axis) graph as denoted by a reference numeral 51. Here, the section setting unit 22 outputs the graph to be displayed on the display device of an information processing terminal operated by the surveillant. Then, with respect to the displayed graph 51 of the abnormal degree, the section setting unit 22 receives designation of a section from the surveillant, and sets it as a notice unneeded section W1 of the abnormal state. For example, in the case where the surveillant recognizes a period (time) that the monitoring object P is in a maintenance operation or a part replacement operation, the surveillant designates the period. Note that the section setting unit 22 may set a previously set period as a notice unneeded section W1, without receiving a designation of the section from the surveillant. However, it is not limited that the section setting unit 22 sets the notice unneeded section W1 on the graph 51 of the abnormal degree. For example, the section setting unit 22 may set a section designated by the surveillant as described above or a previously set section as the notice unneeded section W1 on the time-series data set as denoted by the reference numeral 41. The section setting unit 22 may set the notice unneeded section W1 by any method.

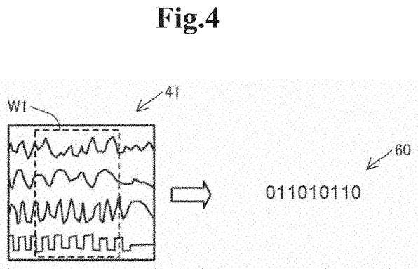

The state encoding unit 23 generates, from the time-series data set in the notice unneeded section W1 set as described above, state identification information (state information) representing the state of the time-series data set. In the present embodiment, the state encoding unit 23 generates state identification information 60 obtained by encoding the time-series data set in the notice unneeded section W1 into a binary vector, as illustrated in FIG. 4. For example, the state encoding unit 23 converts the time-series data set in the notice unneeded section W1 into a real number vector, and further converts the real number vector into a binary vector. Here, a real number vector means a vector in which the value of each dimension takes a real number. Note that the state encoding unit 23 may encore the time-series data set into a code of any format without being limited to a binary vector, and may encode it by any method.

Then, the state encoding unit 23 stores the state identification information 60 generated from the time-series data set in the notice unneeded section W1 having been set, in the state identification information storage unit 17. Note that the correlation model stored in the model storage unit 16 and the state identification information 60 stored in the state identification information storage unit 17 serve as reference data to be used for analysis of the time-series data performed later. That is, the state encoding unit 23 generates and stores the state identification information 60 to thereby update the reference data to be used for analysis of the time-series data. Here, the state encoding unit 23 may previously store event information generated in the notice unneeded section W1 in association with the state identification information 60. For example, the event information includes information representing the content of the situation actually performed such as “maintenance”, information about a person in charge of the event and the date/time of the event, and the like.

Note that in the present embodiment, the state of the monitoring object P is analyzed and output of the abnormal degree and the notice information is controlled using the reference data including the correlation model and the state identification information 60, as described below. However, the reference data is not limited to the correlation model and the state identification information as described above. That is, as reference data, any information may be used if it is information that can be used for analyzing a time-series data set and detecting a time-series data set that is the same as the time-series data set in the notice unneeded section W1.

Next, a process of analyzing and monitoring the state of the monitoring object P by the analysis unit 13 will be described. The analysis unit 13 inputs therein a time-series data set (second time-series data) that is newly measured from the monitoring object P thereafter, analyzes whether or not an abnormal state has occurred in the monitoring object P, and monitors it. Specifically, the abnormal degree calculation unit 21 first inputs therein a time-series data set (second time-series data) measured from the monitoring object P, and calculates the abnormal degree representing the degree that the monitoring object P is in an abnormal state, with use of a correlation model (reference data) stored in the model storage unit 16, as similar to the above-described case.

In parallel with calculation of the abnormal degree, the state encoding unit 23 generates, from the time-series data set measured from the monitoring object P, state identification information representing the state of the time-series data set. Here, the state encoding unit 23 generates state identification information obtained by encoding the time-series data set into a binary vector, as similar to the above-described case. Note that the state encoding unit 23 generates state identification information with respect to time-series data sets for all of the newly measured given sections. However, the state encoding unit 23 may generate state identification information representing the state of the time-series data set, only from the time-series data set of the time when the abnormal degree determination unit 24 determines that an abnormal state has occurred, from the abnormal degree.

Then, the abnormality determination unit 24 of the analysis unit 13 determines whether or not an abnormal state has occurred in the monitoring object P, from the abnormal degree calculated from the monitoring object P. For example, the abnormality determination unit 24 determines that an abnormal state has occurred when a state where the abnormal degree is a preset threshold or larger continues for a certain time. However, the abnormality determination unit 24 may determine occurrence of an abnormal state according to any reference. Then, as an analysis result of an abnormal state of the time-series data set, the abnormality determination unit 24 notifies the output unit 14 of a determination result of whether or not an abnormal state has occurred, together with the abnormal degree.

Moreover, the abnormality determination unit 24 determines whether information that is the same as the state identification information generated from the time-series data set is stored in the state identification information storage unit 17, that is, whether the newly generated state identification information is registered in the state identification information storage unit 17. Then, as an analysis result of the abnormal state of the time-series data set, the abnormality determination unit 24 notifies the output unit 14 of a determination result of whether or not the state identification information is registered in the state identification information storage unit 17, together with the abnormal degree and the determination result of the abnormal state. As described above, when the state identification information is generated only from the time-series data set of the time when an abnormal state is determined to be occurred from the abnormal degree, the abnormal degree determination unit 24 determines whether or not such state identification information is registered in the state identification information storage unit 17. In that case, when it is not determined that an abnormal state has occurred, state identification information is not generated. Therefore, the abnormality determination unit 24 does not determine whether or not state identification information is registered in the state identification information storage unit 17, and notifies the output unit 14 of only the abnormal degree and a determination result of whether or not an abnormal state has occurred.

Note that the abnormality determination unit 24 may determine that the generated state identification information is registered, when the state identification information generated from the time-series data set and similar information according to the preset reference or corresponding information are stored in the state identification information storage unit 17. That is, the abnormality determination unit 24 may determine that the generated state identification information is registered in the state identification information storage unit 17 not only in the case where the generated state identification information and the information stored in the state identification information storage unit 17 are completely identical but also in the case where it can be determined that those pieces of information correspond to each other according to the preset reference.

The output unit 14 controls output of information related to an abnormal state on the basis of the analysis result of the time-series data set. At that time, on the basis of the determination result of whether or not an abnormal state has occurred and the determination result of whether or not the state identification information is registered, the output unit 14 determines whether or not an abnormal state has occurred and notice to the surveillant is needed, and controls whether or not to output notice information to the surveillant. For example, when it is determined that an abnormal state has occurred and state identification information generated from the time-series data set is not registered in the state identification information storage unit 17, notice information is output to the surveillant. At that time, the output unit 14 transmits notice information representing that abnormality has occurred to the registered email address of the surveillant, or outputs notice information so as to display it on the display screen of the monitoring terminal operated by the surveillant connected to the time-series data processing device 10.

Meanwhile, even when it is determined that an abnormal state has occurred according to the abnormal degree, when the state identification information generated from the time-series data set is not registered in the state identification information storage unit 17, the output unit 14 stops outputting of notice information to the surveillant. That is, even though an abnormal state has occurred, the fact that an abnormal state has occurred is not notified to the surveillant.

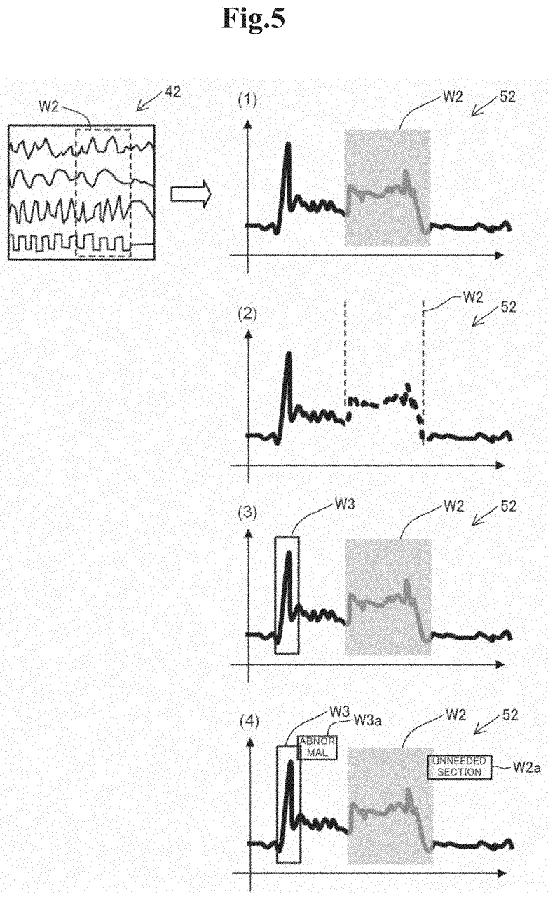

The output unit 14 also outputs the abnormal degree of the monitoring object P to the surveillant. Here, the output unit 14 displays the abnormal degree of the case where the state identification information is registered, by distinguishing it from the other abnormal degrees. For example, in the case where the time-series data set denoted by a reference numeral 42 in FIG. 5 is measured and the state identification information of the section denoted by a reference sign W2 is registered, the abnormal degree corresponding to the section W2 is displayed in a manner distinguishable from the other abnormal degrees. As an example, in the example of (1) of FIG. 5, in the graph of abnormal degree, the section W2 in which the state identification information is registered is shown with a given color so as to be distinguishable from the other sections. In the example of (2) of FIG. 5, the graph itself of the abnormal degree of the section W2 in which the state identification information is registered is shown by a dotted line, and the other sections are shown by solid lines.

Note that in the graph of abnormal degree, in addition to indicating the abnormal degree in which the state identification information is registered while distinguishing it from the other abnormal degrees, the output unit 14 may display the abnormal degree determined to be in an abnormal state while distinguishing it from the other abnormal degrees. As an example, in the example of (3) of FIG. 5, in the graph of abnormal degree, a section S3 in which state identification information is not registered and it is determined to be in an abnormal state is shown by being enclosed with a frame so as to be distinguishable from the other sections.

The output unit 14 may also display text information representing the state of the abnormal degree in the graph of abnormal degree. For example, as illustrated in (4) of FIG. 5, it is possible to display the text of “unneeded section” W2a indicating that a notice in unneeded for the section W2 in which state identification information is registered, and to display the text “abnormal” W3a for the section determined to be in an abnormal state. Here, for the section W2 in which state identification information is registered, the output unit 14 may display event information (information about the content of the event, a person in charge, date/time, and the like) associated with the state identification information.

### [Operation]

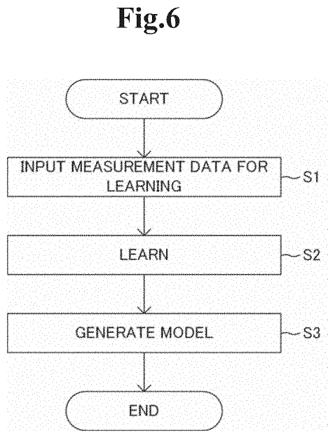

Next, operation of the time-series data processing device system 10 as described above will be described with reference to the flowcharts of FIGS. 6 to 8. First, an operation of generating a correlation model representing a correlation between elements when the monitoring object P is in a normal state will be described with reference to the flowchart of FIG. 6.

The time-series data processing device 10 reads, from the measurement data storage unit 15, data for learning that is a time-series data set measured when the monitoring object P is determined to be in a normal state, and stores it therein (step S1). Then, the time-series data processing device 10 learns the correlation between the elements from the input time-series data (step S2), and generates a correlation model representing the correlation between the elements (step S3).

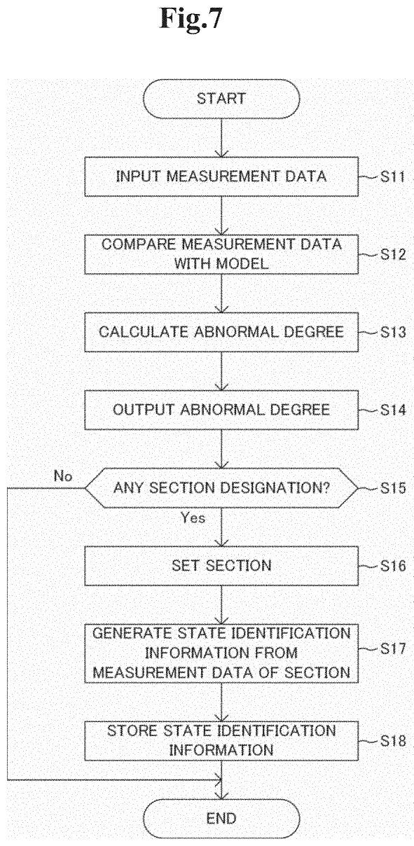

Next, a process of setting a notice unneeded period of an abnormal state of the monitoring object P will be described with reference to the flowchart of FIG. 7. First, the time-series data processing device 10 inputs therein a time-series data set (first time-series data) newly measured from the monitoring object P (step S11). Then, the time-series data processing device 10 compares the input time-series data set with the correlation model stored in the model storage unit 16 (step S12), and calculates the abnormal degree representing the degree that the monitoring object P is in an abnormal state (step S13). Here, the time-series data processing device 10 inputs, to a correlation function between given two elements included in the correlation model, a measured input value of one element to thereby predict an output value of the other element, obtains the difference between the predicted value and the actual measurement value, and calculates the abnormal degree according to the magnitude of the difference, the weight of the correlation function, the number of correlations in correlation destruction, and the like.

Then, as illustrated in FIG. 3, the time-series data processing device 10 outputs the graph 51 of abnormal degree calculated from the time-series data set 41. Here, the section setting unit 22 outputs the graph so as to be displayed on the display device of an information processing terminal operated by the surveillant (step S14). Then, with respect to the graph 51 of abnormal degree, when receiving designation of a section from the surveillant (Yes at step S15), the time-series data processing device 10 sets the section as a notice unneeded section W1 of abnormal state, as denoted by the reference sign W1 in FIG. 3 (step S16). Note that the time-series data processing device 10 may automatically set the previously set period as the notice unneeded section W1, without receiving designation of the section from the surveillant.

Then, as illustrated in FIG. 4, the time-series data processing device 10 generates, from the time-series data set in the notice unneeded section W1 having been set, the state identification information 60 representing the state of the time-series data set (step S17). At that time, the time-series data processing device 10 generates the state identification information 60 obtained by encoding the time-series data set in the notice unneeded section W1 into a binary vector. Then, the time-series data processing device 10 stores the generated state identification information 60 in the state identification information storage unit 17 (step S18). Thereby, the time-series data processing device 10 stores the state identification information 60 represented by the binary vector representing the characteristics of the time-series data set that is set to be notice unneeded. At that time, the time-series data processing device 10 stores the state identification information 60 represented by the binary vector in association with event information generated in the notice unneeded section W1.

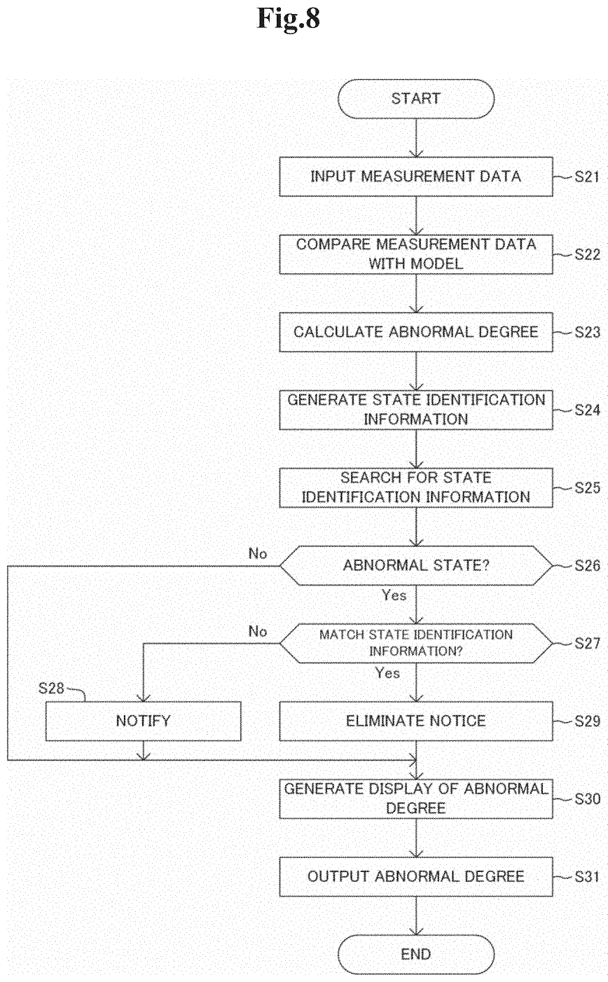

Next, a process of analyzing and monitoring the state of the monitoring object P will be described with reference to the flowchart of FIG. 8. First, the time-series data processing device 10 inputs therein a time-series data set (second time-series data) newly measured from the monitoring object P (step S21). Then, the time-series data processing device 10 compares the input time-series data set with the correlation model stored in the model storage unit 16 (step S22), and calculates the abnormal degree representing the degree that the monitoring object P is in an abnormal state (step S23). Here, the time-series data processing device 10 inputs, to a correlation function between given two elements included in the correlation model, a measured input value of one element to thereby predict an output value of the other element, obtains the difference between the predicted value and the actual measurement value, and calculates the abnormal degree according to the magnitude of the difference, the weight of the correlation function, the number of correlations in correlation destruction, and the like

The time-series data processing device 10 also generates, from the time-series data set measured from the monitoring object P, state identification information representing the state of the time-series data set (step S24). At that time, as the state identification information, state identification information obtained by encoding the time-series data set into a binary vector is generated. Then, the time-series data processing device 10 determines whether or not information identical to the generated state identification information is stored in the state identification information storage unit 17, that is, whether or not the generated state identification information is registered in the state identification information storage unit 17 (step S25).

Then, the time-series data processing device 10 determines whether or not an abnormal state has occurred in the monitoring object P, from the calculated abnormal degree (step S26). For example, the abnormality determination unit 24 determines that an abnormal state has occurred when a state where the abnormal degree is a preset threshold or larger continues for a certain time. Then, upon determining that an abnormal state has occurred in the monitoring object P (Yes at step S26), the time-series data processing device 10 considers the determination result of whether or not the state identification information generated as described above is registered in the state identification information storage unit 17 (step S27) to control whether or not to notify the surveillant of occurrence of the abnormal state. For example, when an abnormal state has occurred in the monitoring object P (Yes at step S26), if state identification information generated from the time-series data set at that time is not registered in the state identification information storage unit 17 (No at step S27), notice information is output to the surveillant (step S28). On the other hand, even when an abnormal state has occurred in the monitoring object P (Yes at step S26), if state identification information generated from the time-series data set at that time is registered in the state identification information storage unit 17 (Yes at step S27), notice information is not output to the surveillant (step S29).

Further, on the basis of the determination result of whether or not the abnormal state has occurred and the determination result of whether or not the state identification information is registered, the time-series data processing device 10 generates display information for outputting the abnormal degree (step S30), and outputs it to be displayed to the surveillant (step S31). For example, as illustrated in FIG. 5, when the state identification information 60 generated from the time-series data set is registered, it may be displayed to show that it is a notice unneeded section or that it is a section in which an abnormal state has occurred. However, when an abnormal state has not occurred (No at step S26), the time-series data processing device 10 may omit generation of display information of the abnormal degree (step S30) and displaying and outputting of display information of the abnormal degree (step S31).

Note that while, in the above description, the abnormal degree itself is output to be displayed and, when an abnormal state occurs, the fact is also notified to the surveillant. However, either one of the displaying and outputting of the abnormal degree itself and the notification to the surveillant may be performed.

As described above, in the present invention, a section of time-series data measured in advance (first time-series data) is designated, and on the basis of the time-series data included in the section, output of information based on the analysis result with respect to the subsequent time-series data (second time-series data) is controlled. That is, when the time-series data corresponding to the designated section of the previously measured time-series data is identical to the subsequent time-series data, output is controlled by eliminating a notice of the abnormal state or changing the display of the abnormal degree. Therefore, it is possible to improve the accuracy of monitoring by the surveillant with respect to the monitoring object, such as suppressing of an unnecessary output of abnormal detection with respect to the time-series data.

### Second Exemplary Embodiment

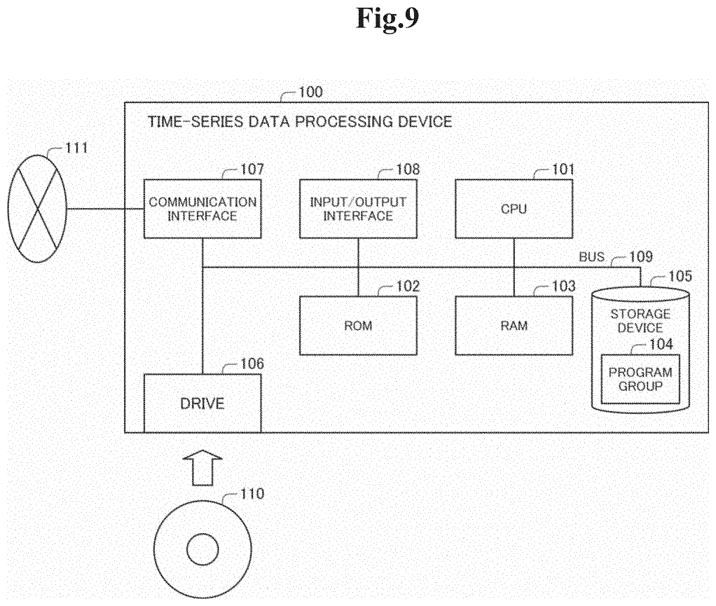

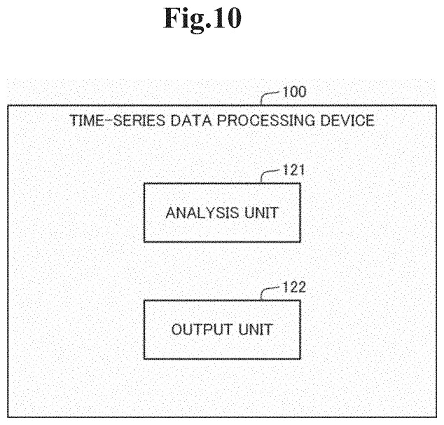

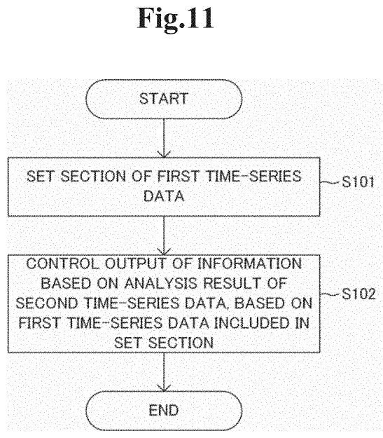

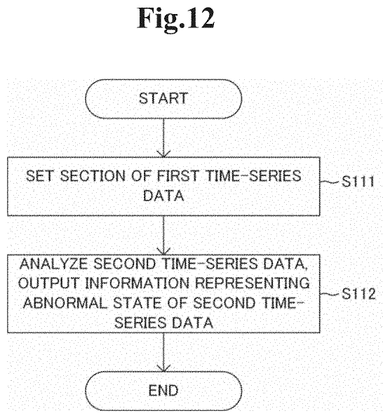

Next, a second exemplary embodiment of the present invention will be described with reference to FIGS. 9 to 12. FIGS. 9 and 10 are block diagrams illustrating a configuration of a time-series data processing device of the second exemplary embodiment, and FIGS. 11 and 12 are flowcharts illustrating the operation of the time-series data processing device. Note that the present embodiment shows the outlines of the time-series data processing device and the time-series data processing method described in the first exemplary embodiment.

First, a hardware configuration of a time-series data processing device 100 in the present embodiment will be described with reference to FIG. 9. The time-series data processing device 100 is configured of a typical information processing device, having a hardware configuration as described below as an example.
Central Processing Unit (CPU) 101 (arithmetic unit)
Read Only Memory (ROM) 102 (storage unit)
Random Access Memory (RAM) 103 (storage unit)
Program group 104 to be downloaded to the RAM 103
Storage device 105 storing therein the program group 104
Drive 106 that performs reading and writing on a storage medium 110 outside the information processing device
Communication interface 107 connecting to a communication network 111 outside the information processing device
Input/output interface 108 for performing input/output of data
Bus 109 connecting the constituent elements

The time-series data processing device 100 can construct and be equipped with the analysis unit 121 and the output unit 122 illustrated in FIG. 10 through acquisition of the program group 104 and execution thereof by the CPU 101. The program group 104 is stored in the storage device 105 or the ROM 102 in advance, and is loaded to the RAM 103 by the CPU 101 as needed. Further, the program group 104 may be provided to the CPU 101 via the communication network 111, or may be stored on the storage medium 110 in advance and read out by the drive 106 and supplied to the CPU 101. However, the analysis unit 121 and the output unit 122 may be constructed by electronic circuits.

Note that FIG. 9 illustrates an example of the hardware configuration of the information processing device that is the time-series data processing device 100. The hardware configuration of the information processing device is not limited to that described above. For example, the information processing device may be configured of part of the configuration described above, such as without the drive 106.

Then, the time-series data processing device 100 executes the time-series data processing method illustrated in the flowchart of FIG. 11 or FIG. 12, by the functions of the analysis unit 121 and the output unit 122 constructed by the program as described above.

As illustrated in FIG. 11, the time-series data processing device 100

sets, on the basis of an analysis result with respect to first time-series data, a given section of the first time-series data (step S101), and

on the basis of the first time-series data included in the set section, controls output of information based on an analysis result with respect to second time-series data (step S102).

Further, as illustrated in FIG. 12, the time-series data processing device 100

sets, on the basis of an analysis result with respect to first time-series data, a given section of the first time-series data (step S111),

analyzes second time-series data, and outputs information representing an abnormal state of the second time-series data (step S112), and

when outputting the information representing the abnormal state of the second time-series data, outputs information representing an abnormal state of the second time-series data corresponding to the first time-series data included in the set section, of the information representing the abnormal state of the second time-series data, so as to be distinguishable from the rest.

With the configurations described above, in the present invention, a section of time-series data (first time-series data) measured in advance is designated, and on the basis of the time-series data included in the section, output of information based on an analysis result with respect to the subsequent time-series data (second time-series data) is controlled. For example, when the time-series data corresponding to the designated section of the previously measured time-series data is identical to the subsequent time-series data, output is controlled by eliminating a notice of the abnormal state or changing the display of the abnormal degree. Therefore, it is possible to improve the accuracy of monitoring by the surveillant with respect to the monitoring object, such as suppressing of an unnecessary output of abnormal detection with respect to the time-series data.

### <Supplementary Notes>

The whole or part of the exemplary embodiments disclosed above can be described as, but not limited to, the following supplementary notes. Hereinafter, outlines of the configurations of a time-series data processing method, a time-series data processing device, and a program, according to the present invention, will be described. However, the present invention is not limited to the configurations described below.

### (Supplementary Note 1)

A time-series data processing method comprising:

on a basis of an analysis result with respect to first time-series data, setting a given section of the first time-series data; and

on a basis of the first time-series data included in the set section, controlling output of information based on an analysis result with respect to second time-series data.

### (Supplementary Note 2)

The time-series data processing method according to supplementary note 1, further comprising:

analyzing the first time-series data with use of reference data set in advance, and setting the section of the first time-series data on a basis of an analysis result;

updating the reference data on a basis of the first time-series data included in the set section; and

analyzing the second time-series data with use of the updated reference data, and controlling output of information based on an analysis result.

### (Supplementary Note 3)

The time-series data processing method according to supplementary note 2, further comprising:

analyzing the first time-series data with use of the reference data, and outputting information representing an abnormal state of the first time-series data, and

on a basis of the output information representing the abnormal state of the first time-series data, setting the section of the first time-series data.

### (Supplementary Note 4)

The time-series data processing method according to supplementary note 3, further comprising:

analyzing the second time-series data with use of the updated reference data, and on a basis of an analysis result, controlling whether or not to output notice information notifying that the second time-series data is in an abnormal state.

### (Supplementary Note 5)

The time-series data processing method according to supplementary note 4, further comprising:

according to the analysis result with respect to the second time-series data, when the second time-series data is determined to be in an abnormal state and the second time-series data corresponds to the time-series data included in the set section, performing control to stop output of the notice information.

### (Supplementary Note 6)

The time-series data processing method according to any of supplementary notes 1 to 5, further comprising:

generating state information representing a state of the first time-series data included in the set section; and

analyzing the second time-series data with use of the state information, and controlling output of information based on an analysis result.

### (Supplementary Note 7)

The time-series data processing method according to supplementary note 6, further comprising:

when the second time-series data corresponds to the state information, performing control to stop output of the notice information notifying that the second time-series data is in an abnormal state.

### (Supplementary Note 8)

The time-series data processing method according to any of supplementary notes 1 to 7, further comprising

analyzing the second time-series data, and outputting information representing an abnormal state of the second time-series data, wherein

the outputting includes outputting information representing an abnormal state of the second time-series data corresponding to the first time-series data included in the set section, of the information representing the abnormal state of the second time-series data, so as to be distinguishable from rest.

### (Supplementary Note 9)

A time-series data processing method comprising:

on a basis of an analysis result with respect to first time-series data, setting a given section of the first time-series data; and

analyzing second time-series data, and outputting information representing an abnormal state of the second time-series data, wherein

the outputting the information representing the abnormal state of the second time-series data includes outputting information representing an abnormal state of the second time-series data corresponding to the first time-series data included in the set section, of the information representing the abnormal state of the second time-series data, so as to be distinguishable from rest.

### (Supplementary Note 10)

A time-series data processing device comprising:

an analysis unit that, on a basis of an analysis result with respect to first time-series data, sets a given section of the first time-series data; and

an output unit that, on a basis of the first time-series data included in the set section, controls output of information based on an analysis result with respect to second time-series data.

### (Supplementary Note 11)

The time-series data processing device according to supplementary note 10, wherein

the analysis unit analyzes the first time-series data with use of reference data set in advance, sets the section of the first time-series data on a basis of an analysis result, updates the reference data on a basis of the first time-series data included in the set section, and analyzes the second time-series data with use of the reference data updated, and

the output unit controls output of information based on an analysis result.

### (Supplementary Note 12)

The time-series data processing device according to supplementary note 11, wherein

the analysis unit analyzes the first time-series data with use of the reference data, outputs information representing an abnormal state of the first time-series data, and on a basis of the output information representing the abnormal state of the first time-series data, sets the section of the first time-series data.

### (Supplementary Note 13)

The time-series data processing device according to supplementary note 12, wherein

the analysis unit analyzes the second time-series data with use of the updated reference data, and

on a basis of an analysis result of the second time-series data, the control unit controls whether or not to output notice information notifying that the second time-series data is in an abnormal state.

### (Supplementary Note 14)

The time-series data processing device according to supplementary note 13, wherein

according to the analysis result with respect to the second time-series data, when the second time-series data is determined to be in an abnormal state and the second time-series data corresponds to the first time-series data included in the set section, the control unit performs control to stop output of the notice information.

### (Supplementary Note 15)

The time-series data processing device according to any of supplementary notes 10 to 14, wherein

the analysis unit generates state information representing a state of the first time-series data included in the set section, and analyzes the second time-series data with use of the state information, and

the output unit controls output of information based on an analysis result with respect to the second time-series data.

### (Supplementary Note 16)

The time-series data processing device according to supplementary note 15, wherein

when the second time-series data corresponds to the state information, the output unit performs control to stop output of the notice information notifying that the second time-series data is in an abnormal state.

### (Supplementary Note 17)

The time-series data processing device according to any of supplementary notes 10 to 16, wherein

the analysis unit analyzes the second time-series data, and

the output unit outputs information representing an abnormal state of the second time-series data on a basis of an analysis result with respect to the second time-series data, wherein

when outputting the information, the output unit outputs information representing an abnormal state of the second time-series data corresponding to the first time-series data included in the set section, of the information representing the abnormal state of the second time-series data, so as to be distinguishable from rest.

### (Supplementary Note 18)

A time-series data processing device comprising:

an analysis unit that, on a basis of an analysis result with respect to first time-series data, sets a given section of the first time-series data, and analyzes second time-series data; and

an output unit that, on a basis of an analysis result of the second time-series data, outputs information representing an abnormal state of the second time-series data, wherein

when outputting the information representing the abnormal state of the second time-series data, the output unit outputs information representing an abnormal state of the second time-series data corresponding to the first time-series data included in the set section, of the information representing the abnormal state of the second time-series data, so as to be distinguishable from rest.

### (Supplementary Note 19)

A program for causing an information processing device to execute processing of:

on a basis of an analysis result with respect to first time-series data, setting a given section of the first time-series data; and

on a basis of the first time-series data included in the set section, controlling output of information based on an analysis result with respect to second time-series data.

### (Supplementary Note 20)

A program for causing an information processing device to execute processing of:

on a basis of an analysis result with respect to first time-series data, setting a given section of the first time-series data; and

analyzing second time-series data, and outputting information representing an abnormal state of the second time-series data, wherein

the outputting the information representing the abnormal state of the second time-series data includes outputting information representing an abnormal state of the second time-series data corresponding to the first time-series data included in the set section, of the information representing the abnormal state of the second time-series data, so as to be distinguishable from rest.

Note that the program described above can be supplied to a computer by being stored on a non-transitory computer readable medium of any type. Non-transitory computer readable media include tangible storage media of various types. Examples of non-transitory computer readable media include a magnetic recording medium (for example, flexible disk, magnetic tape, hard disk drive), a magneto-optical recording medium (for example, magneto-optical disk), a CD-ROM (Read Only Memory), a CD-R, a CD-R/W, a semiconductor memory (for example, mask ROM, PROM (Programmable ROM), and EPROM (Erasable PROM), a flash ROM, and a RAM (Random Access Memory). The program described above may also be supplied to a computer by being stored on a transitory computer readable medium of any type. Examples of transitory computer readable media include electric signals, optical signals, and electromagnetic waves. A transitory computer readable medium can be supplied to a computer via a wired communication channel such as an electric wire and an optical fiber, or a wireless communication channel.

While the present invention has been described with reference to the exemplary embodiments described above, the present invention is not limited to the above-described embodiments. The form and details of the present invention can be changed within the scope of the present invention in various manners that can be understood by those skilled in the art.

### REFERENCE SIGNS LIST

10 time-series data processing device
11 measurement unit
12 learning unit
13 analysis unit
14 output unit
15 measurement data storage unit
16 model storage unit
17 state identification information storage unit
21 abnormal degree calculation unit
22 section setting unit
23 state encoding unit
24 abnormality determination unit
100 time-series data processing device
101 CPU
102 ROM
103 RAM
104 program group
105 storage device
106 drive
107 communication interface
108 input/output interface
109 bus
110 storage medium
111 communication network
121 analysis unit
122 output unit

What is claimed is:

1. A time-series data processing method comprising:
on a basis of an analysis result with respect to first time-series data, setting a given section of the first time-series data; and
on a basis of the first time-series data included in the set section, controlling output of information based on an analysis result with respect to second time-series data.

2. The time-series data processing method according to claim 1, further comprising:
analyzing the first time-series data with use of reference data set in advance, and setting the section of the first time-series data on a basis of an analysis result;
updating the reference data on a basis of the first time-series data included in the set section; and
analyzing the second time-series data with use of the updated reference data, and controlling output of information based on an analysis result.

3. The time-series data processing method according to claim 2, further comprising:
analyzing the first time-series data with use of the reference data, and outputting information representing an abnormal state of the first time-series data, and
on a basis of the output information representing the abnormal state of the first time-series data, setting the section of the first time-series data.

4. The time-series data processing method according to claim 2, further comprising:
analyzing the second time-series data with use of the updated reference data, and on a basis of an analysis result, controlling whether or not to output notice information notifying that the second time-series data is in an abnormal state.

5. The time-series data processing method according to claim 4, further comprising:
according to the analysis result with respect to the second time-series data, when the second time-series data is determined to be in an abnormal state and the second time-series data corresponds to the time-series data included in the set section, performing control to stop output of the notice information.

6. The time-series data processing method according to claim 1, further comprising:
generating state information representing a state of the first time-series data included in the set section; and
analyzing the second time-series data with use of the state information, and controlling output of information based on an analysis result.

7. The time-series data processing method according to claim 6, further comprising:
when the second time-series data corresponds to the state information, performing control to stop output of the notice information notifying that the second time-series data is in an abnormal state.

8. The time-series data processing method according to claim 1, further comprising
analyzing the second time-series data, and outputting information representing an abnormal state of the second time-series data, wherein
the outputting includes outputting information representing an abnormal state of the second time-series data corresponding to the first time-series data included in the set section, of the information representing the abnormal state of the second time-series data, so as to be distinguishable from rest.

9. A time-series data processing method comprising:
on a basis of an analysis result with respect to first time-series data, setting a given section of the first time-series data; and
analyzing second time-series data, and outputting information representing an abnormal state of the second time-series data, wherein
the outputting the information representing the abnormal state of the second time-series data includes outputting information representing an abnormal state of the second time-series data corresponding to the first time-series data included in the set section, of the information representing the abnormal state of the second time-series data, so as to be distinguishable from rest.

10. A time-series data processing device comprising:
a memory configured to store instructions; and
at least one processor configured to execute the instructions, the instructions comprising:
on a basis of an analysis result with respect to first time-series data, setting a given section of the first time-series data; and
on a basis of the first time-series data included in the set section, controlling output of information based on an analysis result with respect to second time-series data.

11. The time-series data processing device according to claim 10, wherein the instructions comprise:
analyzing the first time-series data with use of reference data set in advance, setting the section of the first time-series data on a basis of an analysis result, updating the reference data on a basis of the first time-series data included in the set section, and analyzing the second time-series data with use of the reference data updated, and
controlling output of information based on an analysis result.

12. The time-series data processing device according to claim 11, wherein the instructions comprise:
analyzing the first time-series data with use of the reference data, outputting information representing an abnormal state of the first time-series data, and on a basis of the output information representing the abnormal state of the first time-series data, setting the section of the first time-series data.

13. The time-series data processing device according to claim 12, wherein the instructions comprise:
analyzing the second time-series data with use of the updated reference data, and
on a basis of an analysis result of the second time-series data, controlling whether or not to output notice information notifying that the second time-series data is in an abnormal state.

14. The time-series data processing device according to claim 13, wherein the instructions comprise:
according to the analysis result with respect to the second time-series data, when the second time-series data is determined to be in an abnormal state and the second time-series data corresponds to the first time-series data included in the set section, performing control to stop output of the notice information.

15. The time-series data processing device according to claim 10, wherein the instructions comprise:
generating state information representing a state of the first time-series data included in the set section, and analyzing the second time-series data with use of the state information, and
controlling output of information based on an analysis result with respect to the second time-series data.

16. The time-series data processing device according to claim 15, wherein the instructions comprise:
when the second time-series data corresponds to the state information, performing control to stop output of the notice information notifying that the second time-series data is in an abnormal state.

17. The time-series data processing device according to claim 10, wherein the instructions comprise:
analyzing the second time-series data, and
outputting information representing an abnormal state of the second time-series data on a basis of an analysis result with respect to the second time-series data, wherein
the outputting the information includes outputting information representing an abnormal state of the second time-series data corresponding to the first time-series data included in the set section, of the information representing the abnormal state of the second time-series data, so as to be distinguishable from rest.

18-20. (canceled)
